(19) United States
(12) Patent Application Publication
(10) Pub. No.: US 2004/0085476 A1
(43) Pub. Date: May 6, 2004

(54) Electronic image capture system with modular components

(76) Inventor: Matthew Stephen Whalen, Laguna Nigel, CA (US)

Correspondence Address: STETINA BRUNDA GARRED & BRUCKER, 75 ENTERPRISE, SUITE 250, ALISO VIEJO, CA, 92656, US

(21) Appl. No.: 10/616,612

(22) Filed: Jul. 10, 2003

Related U.S. Application Data
(60) Provisional application No. 60/319,389, filed on Jul. 11, 2002.

(51) Int. Cl. H04N 5/225

(52) U.S. Cl. 348/373

(57) ABSTRACT

The present invention relates to a digital image capture system that uses modular replaceable image sensor components. The present invention permits a plurality of image sensors with different optical and opto-electronic properties to be used in the same camera body. The digital camera system of the present invention includes a camera body having a digital interface card connector, lens and series of digital interface cards each of which may interconnected to the camera body. Image sensors are positioned on the interface cards such that it when the card is placed in the camera by engaging the connector, the image sensor is aligned to the light from the lens. A microprocessor affixed within camera body is in electrical communication with said connector for receiving and processing image data communicated through said connector from said image sensor. The digital interface cards further comprise an on board memory for storing the sensor specification data to be read by said microprocessor to enable proper imaging processing operations.

### CROSS-REFERENCE TO RELATED APPLICATIONS

This application claims benefit of U.S. Provisional Application No. 60/319,389 filed Jul. 11, 2002, which is incorporated by reference in its entirety.

### STATEMENT RE: FEDERALLY SPONSORED RESEARCH/DEVELOPMENT

Not Applicable

### BACKGROUND OF THE INVENTION

The present invention relates generally to digital imaging systems having interchangeable image sensors with each of said image sensors having different characteristics. More specifically, the invention provides a camera housing incorporating a connector for receiving digital interface cards, such that when the cards engage the camera, an on board image sensor is positioned to receive light from a camera lens and an on board memory provides critical operating information about the image sensor to a microprocessor positioned within the camera.

Many digital still cameras (DSCs) are an integrated system consisting of the following parts: lenses, optical filters, one or more electronic image sensor arrays, electronic circuits to capture, process and store images from the image sensor array, external memory devices to store and transfer image files, and a display system to preview the captured images. Because the optical and electronic systems comprising a digital camera are so highly integrated and interdependent, there are often limitations in the performance and functionality of these cameras compared to those that use conventional film. In this regard, the sensor components are fixed and may not be accessed for manipulation to create different effects nor are they easily replaceable with updated technology.

For example, in most silver halide-based film cameras, it is a trivial operation to change the image capture characteristics of the device with respect to overall light sensitivity, color response, and image resolution. The photographer merely replaces one roll of film with another one having the desired characteristics. This is not the case for digital cameras. The optical and electronic systems of a digital camera are designed to operate with one specific image sensor array with regard to light sensitivity, color response and spatial resolution.

A film camera user can easily switch from color film to black-and-white film whereas in most digital cameras, images that are converted from color to black-and-white suffer from a reduction in spatial resolution and optical dynamic range. This is a result of the electronic operations required to convert the signals from a Red-Green-Blue (RGB) Bayer-pattern image sensor to a luminance-only image. Film camera users can easily change the inherent optical sensitivity or film speed rating (ISO speed) of the camera by changing a roll of film, but digital camera users are limited by the inherent ISO speed rating of the image sensor that is integrated into the digital camera design. Finally, film users can take advantage of improvements in silver halide film technology without having to purchase new camera systems. With digital still cameras, it is evident from recent technology trends that spatial resolution and optical sensitivity of electronic image sensors will continue to increase. However, the owners of current digital still cameras will have to purchase new cameras to enjoy the benefits of improvements in sensor technology.

Thus there is a great need in the art for digital cameras that can incorporate the flexibility of a film camera by allowing for the use of different image sensors having differing characteristics. Also, there is a great need in the art for digital cameras that can modularly accept components incorporating improvements in image sensor technology.

### BRIEF SUMMARY OF THE INVENTION

The present invention relates to a digital image capture system that uses a modular replaceable digital interface card incorporating image sensor components which enables a user to quickly and easily replace image sensors in the camera analogous to replacing film in a conventional camera. The present invention permits a plurality of image sensors with different optical and opto-electronic properties to be used in the same camera body.

The digital camera system of the present invention includes a camera body with a lens for receiving light into the camera body. The camera body further includes an interface connector to engage digital interface cards. The replaceable digital interface card includes an image sensor positioned on said card such that it when it is placed in the camera by engaging the connector, the image sensor is aligned to the light from the lens. A microprocessor affixed within camera body is in electrical communication with said connector for receiving and processing image data communicated through said connector from said image sensor.

The digital interface card utilized by the present invention, further comprises an on board memory for storing the sensor specification data to be read by said microprocessor to enable proper imaging processing operations. The user can select the use of a variety of image sensors including charge-coupled device sensors and semiconductor sensors. The card further includes a analog to digital converter and a power supply and related power supply circuit for transmitting power to said microprocessor and said interface connector and the other on board components.

### BRIEF DESCRIPTION OF THE DRAWINGS

These as well as other features of the present invention will become more apparent upon reference to the drawings wherein:

FIG. 1 is a block diagram view of the components of the of a digital interface card of the system of the present invention;

FIG. 2a is a cross sectional view of an exemplary digital interface card of the system of present invention showing alignment components and sensor package; and

FIG. 2b is a cross sectional view of an alternate exemplary digital interface card of the system of the present invention showing alignment components and sensor package.

FIG. 3 is view of the camera body engaging a digital interface face card showing the digital imaging system of the present invention; and

FIG. 4 is a cross-sectional side view of the camera body showing the digital interface card inserted in the camera.

### DETAILED DESCRIPTION OF THE INVENTION

The detailed description as set forth below in connection with the appended drawings is intended as a description of the presently preferred embodiments of the present invention, and does not represent the only embodiment of the present invention. It is understood that various modifications to the invention may be comprised by different embodiments and are also encompassed within the spirit and scope of the present invention.

Referring particularly to FIG. 1, there is shown a digital interface card 10 that is utilized in the digital imagining system of the present invention. The digital interface card 10 incorporates an image sensor 12 mounted onto a printed circuit board or similar platform that has a standard dimension (length, width and thickness) so that the digital interface cards 10 can be interchanged with other digital interface cards in the same camera body and transferred to other accepting camera bodies. The electronic image sensor 12 can be mounted on the printed circuit board of the digital interface card in a standard imaging component package (e.g., ceramic or plastic pin grid array, ceramic or plastic ball grid array with an integral transparent window) or it can be mounted directly to the PCB printed circuit board of the interface card 10 as a chip-on-board (COB) component. The image sensors may be comprised of a charge-coupled device (CCD) or a CMOS sensor. It is fundamental in both the CCD and CMOS that they convert incident light into an electronic signal by an incorporated silicon photodiode in which photo electrons are generated when light is absorbed in the active region. Typically the photodiodes are arranged in rows and columns into a pixel array in which each image sensing element in the array is a photodiode. In a CCD, the photoelectrons are transferred as charge packets from each pixel location in the array to an output transistor amplifier circuit that converts the charge packet to an output voltage signal. In a CMOS sensor, the photoelectrons generated at each pixel location are immediately converted to a voltage signal by a combination of transistor amplifiers at the pixel. A chart showing a comparison of operating requirements for the CCD and CMOS sensors are set forth in Table 1 below.

TABLE 1
Comparison of operating requirements for CCD and CMOS sensors

| | CCD | CMOS |
|---|---|---|
| Operating Voltage | Multiple required: (+5, +12 +9 V) | Single (+5 or +3.3 V) |
| Timing Control | Multiple: TTL and non-TTL | Single (clock in) or Multiple: |
| Signals | levels | TTL levels only |
| Output Signal Format | Analog: non-buffered | Analog: buffered and non- |
| | | buffered; Digital: 8/10/12 bit |

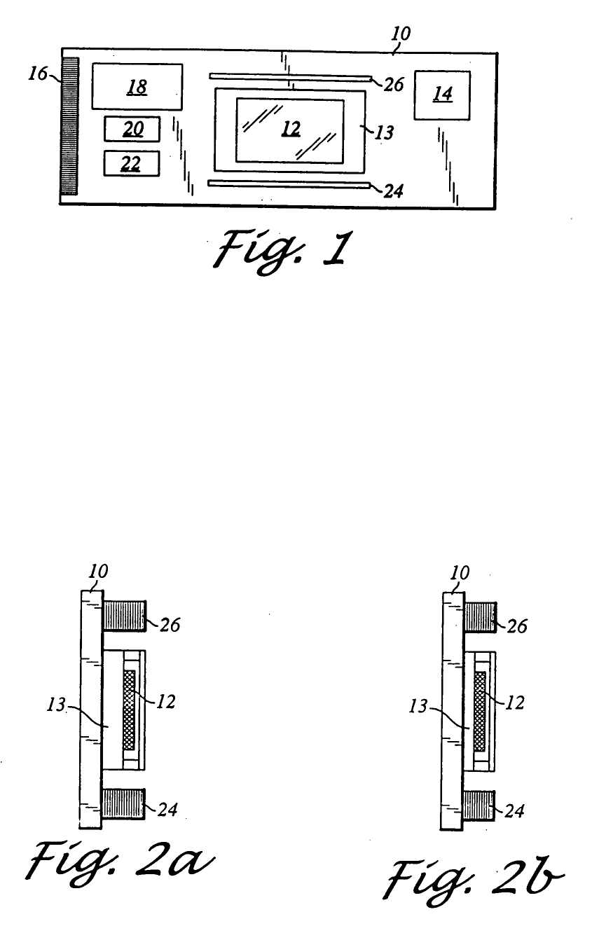

It is contemplated by the present invention that different types of image sensors could be utilized in association with the digital interface card 10 with each of the sensors having differing image characteristics. In this regard, because the image sensor can vary for each digital interface card, a random access memory (RAM) 14 is placed onboard the digital interface card 10 to provide information about the image sensor such that when the digital interface card 10 interfaces with a camera body the electronic components onboard the camera body can determine proper operating voltage and other critical information for operation of the image sensor 12. Both the image sensor 12 and the onboard RAM 14 are in electrical communication with connector interface 16. The connector interface 16 is utilized to engage a connector port (not shown) on a camera body. Power supply circuit 18 may additionally be provided on the digital interface card 10. Also, analog to digital converter circuits 20 and 22 may additionally be provided. Alignment shims 24 and 26 are positioned strategically around the image sensor package 12 to provide a mechanical offset to account for variations in image sensor package thickness as shown in greater detail with respect to FIGS. 2a and 2b.

The RAM module 14, which can be described as a “personality module” can be a read only memory based device that contains a variety of information about the configuration of image sensor 12 and the components onboard the digital interface card 10. When the digital interface card 10 is interfaced with a camera body through the connector interface 16, information on the RAM 14 is transferred to the camera body processing electronics to enable the camera processor to modify the image processing operations it performs on image data from the sensor 12. Examples of the type of information that can be stored on the RAM module 14 are the types of sensors (CMOS or CCD), sensor model number, monochrome or color sensor, sensor resolution, pixel clock frequency, pixel bit depth (8/10/12 bits), coefficients for color correction curves, sensor gamma correction curves, sensor defect maps, and sensitivity or ISO speed rating of the sensor 12.

The analog digital converters 20 and 22 convert the analog voltages from the sensor 12 output into digital values that are transmitted to a processor onboard a camera body. The analog to digital converter sensors are only necessary if the image sensor output is in analog form. Depending on the type of image sensor 12, one or more analog to digital converters may be required to digitize multiple output channels from the sensor 12.

The power supply circuit 18 can be a specifically designed voltage and current generating circuit to power the image sensor 12 on the digital interface card 10 and the RAM 14. The power supply circuit 18 can be designed to draw a single voltage from the camera body circuits and convert that into multiple voltages in the case of a CCD sensor or pass it directly to the image sensor 12 if the image sensor 12 is a CMOS sensor.

Referring to FIGS. 2a and 2b there are shown two distinct cross sections of a digital interface card 10. In particular, the image sensor package 13 incorporating the image sensor 12 is of a differing thickness. Accordingly, the alignment shims 24 and 26 provide mechanical spacing for when the digital interface card is inserted into a camera body. The shims 26 and 24 are sized to conform to the size of the sensor packages 13.

The interface connector 16 is the physical connection between the sensor 12 and related electronics and the camera body. The interface connector 16 will have a standard size, shape and number of electrical connections so that the connector 16 will fit into any digital camera body that has a mating connector. The electrical connections contained in interface connector 16 is shown in Table 2.

TABLE 2
Pinout for UIB connector

| Pin # | Name | Description |
|---|---|---|
| 1 | GND | Ground |
| 2 | Vcc1 | Supply DC voltage #1 for UIB module |
| 3 | SDATA | Serial Data In/Out |
| 4 | SCLK | Serial Data Clock |
| 5 | STROBE | Direction Strobe for Serial Data |
| 6 | DATA0-0 | MSB of Pixel data channel 0 |
| 7 | DATA0-1 | ″ |
| 8 | DATA0-2 | ″ |
| 9 | DATA0-3 | ″ |
| 10 | DATA0-4 | ″ |
| 11 | DATA0-5 | ″ |
| 12 | DATA0-6 | ″ |
| 13 | DATA0-7 | ″ |
| 14 | DATA0-8 | ″ |
| 15 | DATA0-9 | ″ |
| 16 | DATA0-10 | ″ |
| 17 | DATA0-11 | LSB of Pixel Data Channel 0 |
| 18 | GND | Ground |
| 19 | DATA1-0 | MSB of Pixel data Channel 1 |
| 20 | DATA1-1 | ″ |
| 21 | DATA1-2 | ″ |
| 22 | DATA1-3 | ″ |
| 23 | DATA1-4 | ″ |
| 24 | DATA1-5 | ″ |
| 25 | DATA1-6 | ″ |
| 26 | DATA1-7 | ″ |
| 27 | DATA1-8 | ″ |
| 28 | DATA1-9 | ″ |
| 29 | DATA1-10 | ″ |
| 30 | DATA1-11 | LSB of Pixel Data Channel 1 |
| 31 | PIXELCLK | Pixel Clock In |
| 32 | HSYNC_UN | Horizontal/Line Sync In |
| 33 | VSYNC_IN | Vertical/Frame Sync In |
| 34 | HSYNC_OUT | Horizontal/Line Sync Out |
| 35 | VSYNC_OUT | Vertical/Frame Sync Out |
| 36 | Vcc2 | Supply DC Voltage #2 for UIB module |

The interface connector 16 provides for two channels of up to 12-bit pixel data from the image sensor 12, 2 DC supply voltages (if necessary), a 3-line serial communication channel to transfer information from the RAM 14 to processor on board the camera body and also to send register setting data from a camera processor to the image sensor 12, if possible, and 5 timing signal lines (Hsync in and out, Vsysnc in and out and pixel clock) to synchronize the operation of the image sensor 12 with the rest of any camera electronics.

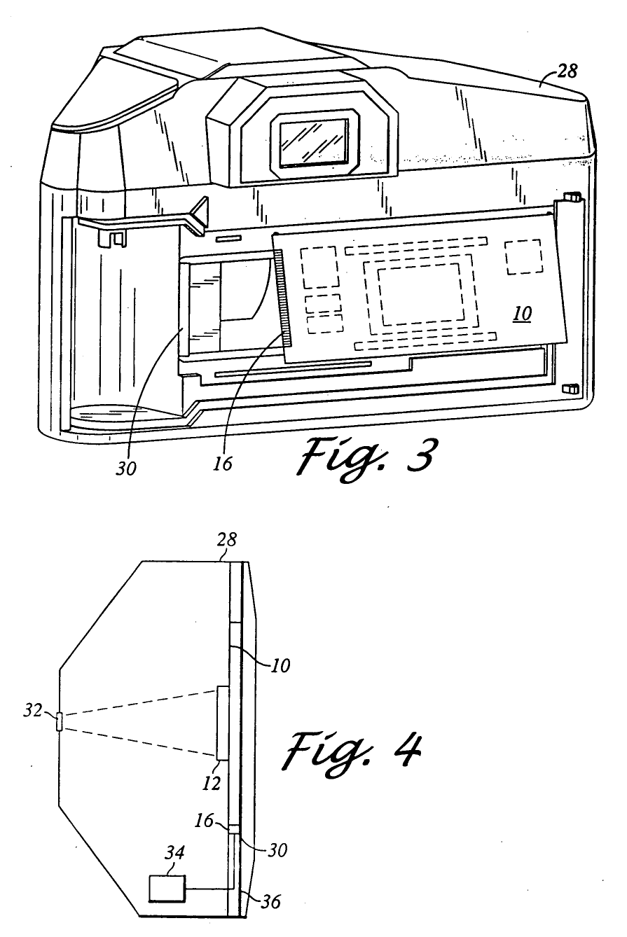

Referring particularly to FIG. 3, there is shown a camera body 28 having onboard electronic components such as a microprocessor (not shown). The digital interface card 10 is shown from the rear with the electronic components shown in phantom. The interface connector 16 mates with camera connector 30 that universally receives a variety of digital interface cards 10 providing connector interfaces 16.

The digital camera body 28 is designed to permit easy insertion and removal of a variety of digital interface cards 10 having differing image sensors. FIG. 3 shows one possible way to incorporate digital interface cards into a digital camera 28.

Referring particularly to FIG. 4, there is shown a cross-sectional side view of the camera body 28 showing a digital interface card inserted in the camera. The camera body 28 is a typical camera housing. The camera housing includes a lens 32 for receiving light into the housing 28. The camera body 28 incorporates a microprocessor 34 and other internal electronics (not shown) which are electrically connected to a camera receptacle connector 30. Because the internal microprocessor 34 and electronics are in electrical communication with the camera connector interface 30, those components can communicate to electronics onboard a digital interface card 10 when the card is mated through the interface connector 16. In this regard, the microprocessor 34 within the camera body 28 can receive processing image data that is communicated through the connector 16 from the image sensor 12. The digital interface card 10 is inserted into the camera body 28. The image sensor 12 which is positioned on said digital interface card 10 is placed within the camera body and is aligned to receive the light from the lens 32 of the camera body.

The process for insertion of the digital interface card 10 into a camera 28 is as follows: The digital camera 28 into which the digital interface card fits is designed with a swing out or fold out back section 36 that exposes the digital interface card 10 insertion area. With the insertion area open, the digital interface card 10 is inserted into a slot or track in the camera 28 back that ensures proper alignment of the module with the focal plane alignment shims 24 and 26 and the interface connector 16. The connector 16 may be of the zero-insertion force (ZIF) variety for ease of use. When the digital interface card 10 has been secured in place in the camera 28 and the connector 16 inserted into the mating receptacle 30 on the camera 28, the camera back 36 is closed and the camera 28 can then be turned on. On power-up, the camera processor 34 senses the type of digital interface card 10 and image sensor 12 that has been inserted by the information transferred from the RAM 14 module. The camera processor may adjust electronic timing and control circuits (not shown), image processing procedures, optical lens settings, camera exposure settings, and/or camera flash settings based on the type of digital interface card in the camera. When a different digital interface card 10 is to be inserted, the first digital interface card 10 can be replaced by powering down the camera, opening the access panel 36 in the camera body 28, disconnecting the connection 16 and sliding the digital interface card out of the camera. By enabling a user to easily change image sensors in the field, digital cameras would acquire an added flexibility that film-based cameras already have.

Additional modifications to the method of the present invention and the devices used in accordance with the method will be apparent to those skilled in the art. It is understood that such additional modifications are within the scope and spirit of the present invention.

What is claimed is:

1. A digital imaging system comprising;
a housing having a lens for receiving optical radiation into said housing;
an interface connector affixed to said housing for engaging digital interface cards;
at least one digital interface card having an image sensor positioned on said card such that it is aligned to receive optical radiation from said lens when said card is engaged with said connector; and
a microprocessor affixed within said housing in electrical communication with said connector for receiving and processing image data communicated through said connector from said image sensor.

2. The digital imaging system of claim 1 wherein said at least one digital interface card further comprises an on board memory for storing the sensor specification data to be read by said microprocessor to enable proper imaging processing operations.

3. The digital imaging system of claim 1 wherein said image sensor is a charge-coupled device sensor.

4. The digital imaging system of claim 1 wherein said image sensor is a semiconductor sensor.

5. The digital imaging system of claim 1 wherein said digital interface card further comprises at least one analog to digital converter.

6. The digital imaging system of claim 1 further comprising a power supply for transmitting power to said microprocessor and said interface connector.

7. The digital imaging system of claim 6 wherein said digital interface card further comprises a power supply circuit for transmitting power from said connector interface to on board components of said digital interface card.

8. A digital imaging system comprising;
a housing having a lens for receiving optical radiation into said housing;
an interface connector affixed to said housing for engaging digital interface cards;
at least one digital interface card comprising:
an image sensor positioned on said card such that it is aligned to receive optical radiation from said lens when said card is engaged with said connector; and
an on board memory for storing the sensor specification data;
a microprocessor affixed within said housing in electrical communication with said connector for receiving and processing image data communicated through said connector from said image sensor and for reading said specification data to enable proper imaging processing operations.

9. The digital imaging system of claim 8 wherein said image sensor is a charge-coupled device sensor.

10. The digital imaging system of claim 8 wherein said image sensor is a semiconductor sensor.

11. The digital imaging system of claim 8 wherein said digital interface card further comprises at least one analog to digital converter.

12. The digital imaging system of claim 8 further comprising a power supply for transmitting power to said microprocessor and said interface connector.

13. The digital imaging system of claim 8 wherein said digital interface card further comprises a power supply circuit for transmitting power from said connector interface to on board components of said digital interface card.

14. A digital camera system comprising;
a camera body having a lens for receiving light into said camera body;
an interface connector affixed to camera body for engaging digital interface cards;
at least one digital interface card having an image sensor positioned on said card such that it is aligned to light from said lens when said card is engaged with said connector; and
a microprocessor affixed within camera body in electrical communication with said connector for receiving and processing image data communicated through said connector from said image sensor.

15. The digital camera system of claim 14 wherein said at least one digital interface card further comprises an on board memory for storing the sensor specification data to be read by said microprocessor to enable proper imaging processing operations.

16. The digital imaging system of claim 14 wherein said image sensor is a charge-coupled device sensor.

17. The digital imaging system of claim 14 wherein said image sensor is a semiconductor sensor.

18. The digital imaging system of claim 14 wherein said digital interface card further comprises at least one analog to digital converter.

19. The digital imaging system of claim 14 further comprising a power supply for transmitting power to said microprocessor and said interface connector.

20. The digital imaging system of claim 19 wherein said digital interface card further comprises a power supply circuit for transmitting power from said connector interface to on board components of said digital interface card.
